(19) United States
(12) Patent Application Publication
(10) Pub. No.: US 2002/0018238 A1
(43) Pub. Date: Feb. 14, 2002

(54) Printer, print control apparatus and method

(76) Inventor: Yoshiaki Hirano, Saitama (JP)

Correspondence Address: FITZPATRICK CELLA HARPER & SCINTO, 30 ROCKEFELLER PLAZA, NEW YORK, NY, 10112, US

(21) Appl. No.: 09/884,065

(22) Filed: Jun. 20, 2001

(30) Foreign Application Priority Data
Jun. 21, 2000 (JP) 185803/2000 (PAT.
May 25, 2001 (JP) 156270/2001 (PAT.

(51) Int. Cl. G06K 15/02; H04N 1/21; G06F 12/00

(52) U.S. Cl. 358/1.16

(57) ABSTRACT

Image data are rotated when transferring the image data to a printer engine which are stored in a storage unit for storing bit map data generated on the basis of print data. The above characteristic permits the rotation of the image data to be made without a decrease in the throughput of a printer and high-speed printing to be carried out.

### BACKGROUND OF THE INVENTION

1. Field of the Invention

The present invention relates to a printer in which a PDL controller and a printer engine constructed in a predetermined recording scheme are connected with each other using a parallel interface and DMA transfer of image data to be printed is carried out via the interface and a control method therefor.

2. Description of the Related Art

Conventionally, a printer of the electrophotographic scheme represented by a laser beam printer receives print data, such as code data or image data, expressed in a form such as PDL (Page Descriptive Language) from an external apparatus such as a host computer, develops bit map data on the basis of the received data by means of PDL board for the development from PDL to bit map data and outputs the developed bit map data as video data to a printer engine.

FIGS. 14 and 15 show the aspect of data transfer between a conventional PDL board and a printer engine. The draw data developed on a memory in the PDL board are transferred to a memory in the engine for each band, in which the development and transfer are executed in a predetermined data unit referred to as a band (1,2, . . . N). Here, the same data are transferred between the PDL board and the printer engine as they are without being subjected to processing such as rotation.

Recently, the resolution of this type of apparatus has highly increased and accordingly a tremendous volume of bit map data is transferred.

Formerly, there has also been an arrangement for transferring bit map data as serial data between a PDL board and a printer engine by means of a serial interface, but recently, bit map data have come to be transferred as parallel data in consideration of an increase in transfer amount as mentioned above.

Namely, there is known an arrangement that the PDL board and the printer engine are connected via a standard parallel interface (hereinafter, referred to as I/F), for example, VL bus, PCI bus or IDE bus to perform data transfer. Using these I/Fs, the bit map data developed in the PDL tend to be once stored in a RAM of the engine body and then printed, or input/output of command/status data tends to be carried out using one and the same bus.

Furthermore, recently, in case of printing on a sheet of a predetermined size, e.g. an A4 sheet, A4 transverse sheets are used in an engine to promote the throughput of printing process. Namely, an approach of conveying a sheet in the main scanning line conformable with a longitudinal direction for the printing is used. In this case, the bit map data transmitted and developed by a host under preconditions of a vertical processing must be rotated at an angle of 90° in any processing step.

Conventionally, in case of making such an image rotation, however, a method of drawing the bit map data rotated by a PDL board at the developing time on a memory in the PDL board has been used, but there is a problem that the development capability of the PDL board is not fully exhibited if draw data are rotated at the developing time in this way.

Besides, there are cases where 90° rotation of image data as mentioned above becomes occasionally unnecessary. In case of printing on an A4 transverse sheet, for example, image data rotated at an angle of 90° must be used, and there occurs a case where an A4 longitudinal sheet is used as emergency refuge for the printing at the engine side when A4 transverse sheets in a cassette are used up. In this case, 90° rotation must be further carried out in the engine body corresponding to A4 longitudinal sheets and thus a loss in processing is great.

Besides, in case of transferring the bit map data developed on a memory in the PDL board to an engine memory, there is a problem that use of a bus common to the commands and status data excludes other devices from obtaining the bus during the transfer of bit map data, preventing the other devices from operating. This problem appears markedly especially in a large throughput high-speed machine.

It is an object of the present invention not only to solve the above problems but to perform the rotation of an image without a resultant decrease in the throughput of a printer and moreover to permit a high-speed printing without a wasteful processing regardless of any printing process circumstance.

### SUMMARY OF THE INVENTION

The present invention is made to eliminate the above conventional disadvantages and provides a printer with a PDL controller and a printer engine constructed in a predetermined recording scheme connected using a parallel interface for the DMA transfer of the image data to be printed via the interface and a control method therefor, in which an arrangement of once writing the draw data developed in the above PDL controller into a buffer memory, reading out the 90° rotated data from the above buffer memory and DMA-transferring them to a memory of the above printer engine is adopted.

Besides, a print control apparatus according to the present invention is characterized by comprising: generator means for generating bit map data on the basis of print data; storage means for storing the bit map data generated by the generator means; and rotator means for rotating the image data in transferring the image data stored in the storage means to a printer engine.

### BRIEF DESCRIPTION OF THE DRAWINGS

FIG. 1 is a block diagram showing the configuration of a control system for a printer in which the present invention is adopted;

FIG. 2 is a block diagram showing in detail the configuration of the PCI controller of FIG. 1;

FIG. 3 is an illustration showing the print data in a RAM of a PDL controller;

FIG. 4 is an illustration showing the print data in a RAM of a printer engine;

FIG. 5 is a state transition diagram showing the operation inside an address counter (348) of FIG. 2;

FIG. 6 is a state transition diagram showing the operation of an address counter (323);

FIG. 7 is an illustration showing the print data in a RAM of a PDL controller;

FIG. 8 is an illustration showing the print data in a RAM of a printer engine;

FIG. 9 is a block diagram showing in detail Second Embodiment of a PCI controller according to the present invention;

FIG. 10 is an illustration showing the print data in a RAM of a PDL controller according to Second Embodiment;

FIG. 11 is an illustration showing the print data in a RAM of a printer engine according to Second Embodiment;

FIG. 12 is an illustration showing the print data in a RAM of a PDL controller according to Second Embodiment;

FIG. 13 is an illustration showing the print data in a RAM of a printer engine according to Second Embodiment;

FIG. 14 is an illustration showing the print data of a conventional PDL board memory;

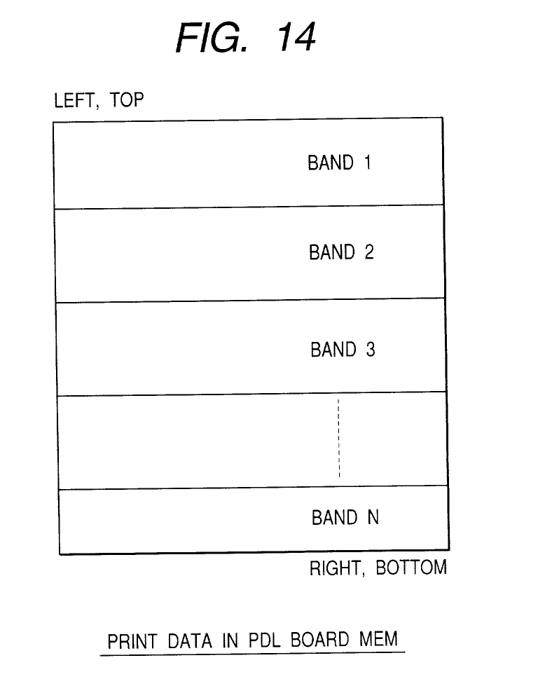

FIG. 15 is an illustration showing the print data in a conventional engine memory;

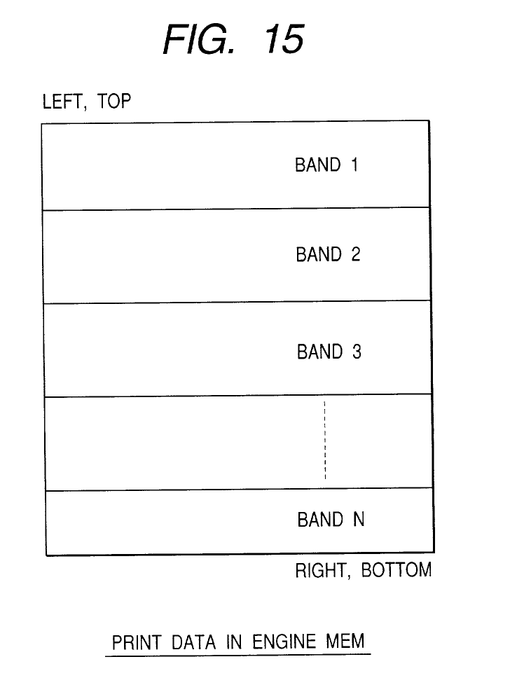

FIG. 16 is an illustration showing a print data transfer method according to Third Embodiment of the present invention;

FIG. 17 is an illustration showing a print data transfer method according to Third Embodiment of the present invention;

FIG. 18 is an illustration showing a print data transfer method according to Third Embodiment of the present invention;

FIG. 19 is an illustration showing a print data transfer method according to Third Embodiment of the present invention;

FIG. 20 is an illustration showing a print data transfer method according to Third Embodiment of the present invention;

FIG. 21 is an illustration showing a print data transfer method according to Third Embodiment of the present invention;

FIG. 22 is a block diagram showing the configuration of a control system for a printer according to Fourth Embodiment of the present invention;

FIG. 23 is a block diagram showing in detail the configuration of the PCI controller of FIG. 22;

FIG. 24 is a block diagram showing a partial modification of the configuration of FIG. 23; and

FIG. 25 is a block diagram showing a partial modification of the configuration of FIG. 22.

### DESCRIPTION OF THE PREFERRED EMBODIMENTS

According to the present invention, in case of printing A4 image data received from a host on an A4 transverse sheet to improve the throughput, draw data of a longitudinal sheet size are generated in a memory without rotation processing at a PDL controller side and a buffer memory provided in a PCI controller is used to rotate the draw data when DMA-transferring the draw data from a memory within a PDL board to an engine memory via the PCI controller (basic configurations of First to Fifth Embodiments) rather than developing the received image data as bit map data rotated at the PDL controller side and implementing drawing for each band to generate draw data of A4 transverse sheet size as conventional.

Besides, by contriving the configuration of a buffer memory (FIFO) provided in a PCI controller (Second Embodiment) or the transfer method (Third Embodiment), the present invention performs a more effective image data transfer.

Furthermore, depending on whether the presence or absence of sheets at the engine side, the present invention controls whether the developed data is rotated or not at the time of data transfer from a PDL controller to a printer engine (Fourth Embodiment).

Besides, among the print data inputted from an external apparatus in the present invention, commands/status data or letter data made up of character codes are transferred from a memory in the PDL controller via the PCI controller to a memory in the printer engine by using a common bus, whereas image data, i.e. bit map data developed by means of the PDL controller are transferred by using no common bus but a dedicated bus (Fifth Embodiment).

Hereinafter, referring to the accompanying drawings, embodiments of the present invention (First to Fourth Embodiment) will be described in sequence. In individual embodiments, identical reference numerals are used for identical or similar members and the detailed description thereof is to be omitted.

First Embodiment

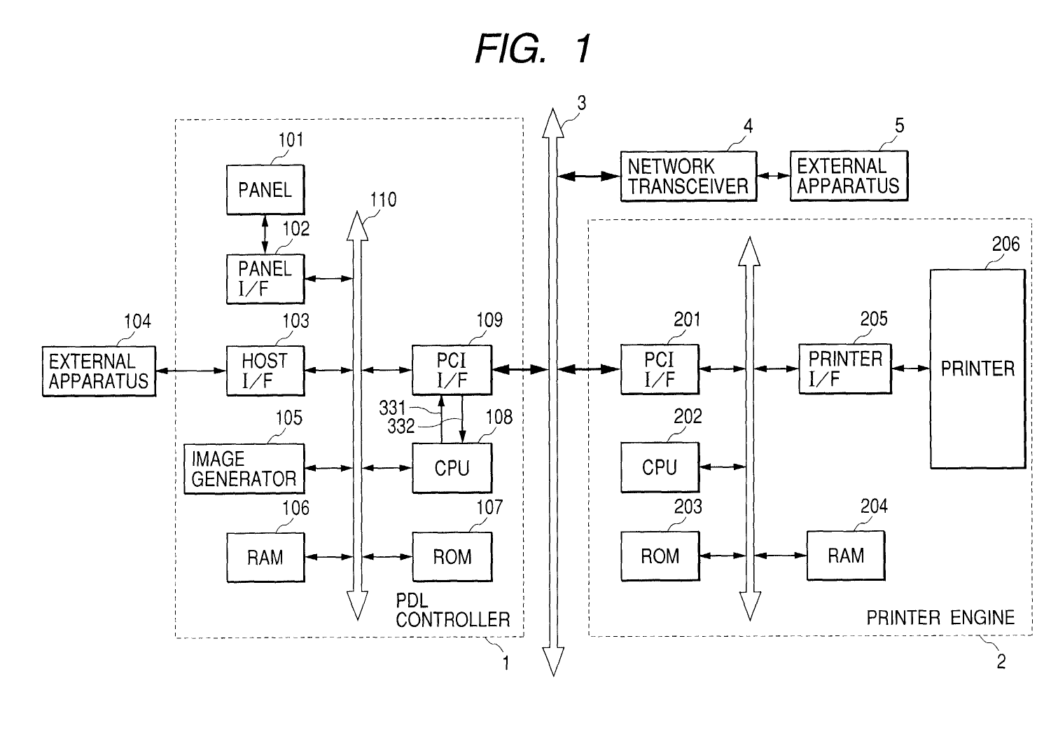

FIG. 1 shows the configuration of a printing system to which the present invention is applied. The apparatus of FIG. 1 is so arranged as to use a PCI bus 3 for the connection of a PDL controller 1 and a printer engine 2.

In the PDL controller 1, reference numeral 101 denotes a display panel for a user interface, which is connected to a bus 110 in the PDL via a panel I/F 102.

Reference numeral 103 denotes a host I/F, which is provided for the connection to an external apparatus 104 such as personal computers and comprises an interface such as IEEE 1284.

Reference numeral 105 denotes an image generator for generating image data, which writes the bit map data (image data) developed from the print data of the PDL form or the like received from a host I/F 103 into a RAM 106.

In a ROM 107 of the PDL controller 1, the program of the CPU 108 for controlling the operation of the PDL controller 1 and the font data thereof are written.

Reference numeral 109 denotes a PCI controller for transferring the image data and commands/status data written in the RAM 106 to the printer engine 2, which is connected to a PCI bus 3.

Reference numeral 331 denotes a CPU control signal outputted from the CPU 108 to the PCI controller 109 and reference numeral 332 denotes a bus control signal outputted from the PCI controller 109 to CPU 108.

Reference numeral 4 denotes a network transceiver connected to the PCI bus 3 and further connected via a network (such as Ethernet) to an external apparatus 5, while the PDL controller 1 can receive a PDL code not only via the external apparatus 104 mentioned above but via the external apparatus 5, the network transceiver 4, the PCI bus 3 and the PCI controller 109 also.

On the other hand, in the printer engine 2, the PCI I/F 201 is a PCI controller inside the printer engine and transfers the bit map data and commands/status data sent via the RAM 106 and the PCI controller 109 of the PDL controller 1 to a RAM 204 inside the printer engine. Besides, the commands/status data from the printer engine 2 are DMA-transferred from the RAM 204 to the RAM 106 via the PCI controllers 201 and 109.

Reference numerals 202 and 203 denote a CPU for controlling the operation of the printer engine and a ROM, while reference numeral 205 denotes a printer I/F for transferring the image data stored in the RAM 204 to a printer 206. The printer 206 is a recording mechanism made up in a recording scheme such as the laser beam scheme.

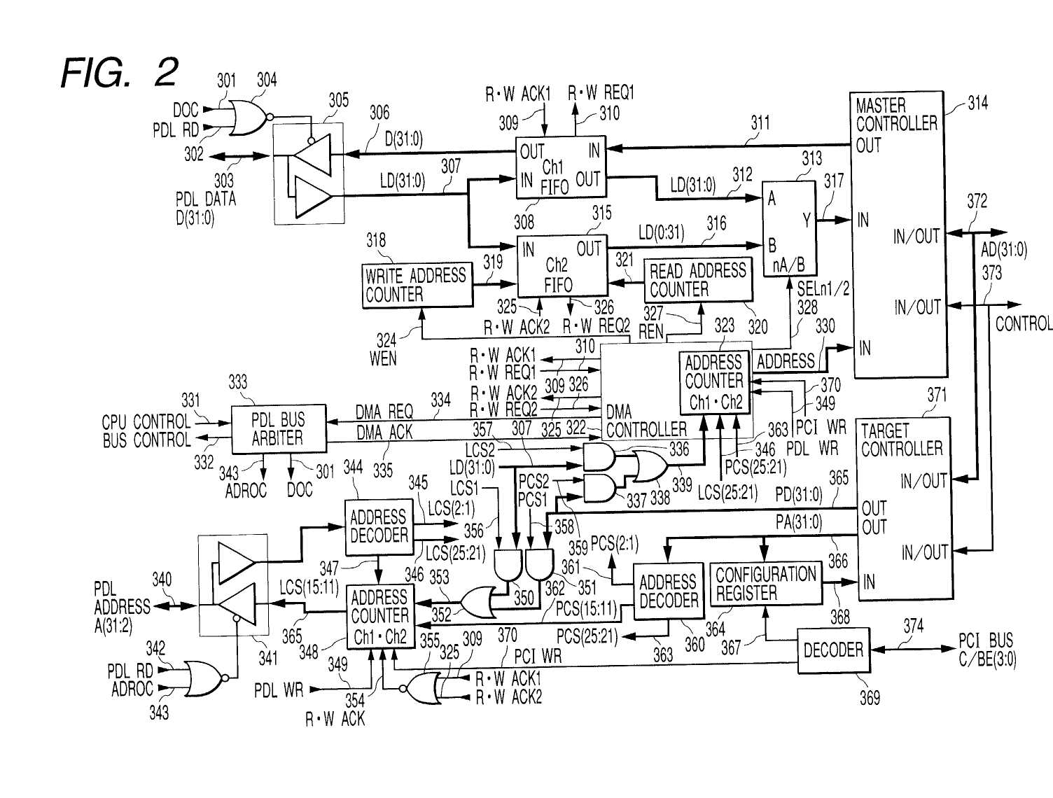

FIG. 2 shows the internal structure of the above PCI controller 109 in detail. In FIG. 2, reference numerals 303 and 340 denote a data bus in the PDL board and an address bus in the PDL board, respectively.

Reference numerals 372, 373 and 374 denote signals at the PCI bus 3 side, which correspond to an AD (address data) signal, a control signal and a command/byte enable signal, respectively.

In the transfer case of status data from the RAM 106 (FIG. 1) in the PDL controller 1 to the RAM 204 (FIG. 1) in the engine body, the status data are once stored from the PDL data bus 303 via a bidirectional buffer 305 and via a data bus 307 with the sequence of data remaining unchanged (31:0) in a buffer memory FIFO 308, then outputted via a data bus 312, a selector 313 in which the A input is selected in response to a selection signal 328, a data bus 317 and a master controller 314 to the PCI bus 372 and written into the RAM 204 via a PCI controller 201.

Incidentally, such a notation as (31:0) attached to a signal line in FIG. 2 represents the number of bits transferred by the relevant signal line or the position. For example, (31:0) means a 32-bit signal (line), where the left and right sides of “:” is to represent the MSB side and the LSB side, respectively.

The transfer destination address and the transfer source address can be set by means of the engine CPU 202 and the CPU 108 in PDL, while at first, an approach of setting by means of the CPU 202 will be described below.

The data transfer from the PDL RAM 106 to the RAM 204 in the engine body and the data transfer from the RAM 204 in the engine body to the PDL RAM 106 are controlled in DMA transfer by the DMA controller 322 and DMA controllers serving for two channels are present in the DMA controller 322.

The transfer destination address to the RAM 204 is set by the engine CPU 202 via the PCI address bus 372, a target controller 371, a data bus 365, an AND circuit 337, an OR circuit 338 and a data bus 339 in an address counter 323 in the DMA controller 322, further inputted via an address bus 330 to the master controller 314 and outputted from the PCI address bus 372. Here, address counters serving for two channels are present in the address counter 323, in which a transfer destination address is set in the channel 1 address counter.

Besides, a transfer source address is set up by the engine CPU 202 via the PCI address data bus 372, the target controller 371, the data bus 365, an AND circuit 351, an OR circuit 352 and the data bus 353 in an address counter 348 and outputted via a bidirectional buffer 341 to the address bus 340. Incidentally, also in the address counter 348, address counters serving for two channels are present and here, a transfer source address is set up in the channel 1 address counter. Here, in case of DMA transfer via the FIFO 308, the channel 1 in the address counters 323 and 348 is used, whereas the channel 2 in the counters 323 and 348 is used in case of DMA transfer via the FIFO 315.

Here, via the command/byte enable signal 374 and a decoder 369, a write signal 370 is generated and outputted to the address counters 323 and 348. Besides, by the PCI address bus 372, the target controller 371, the address bus 366 and the address decoder 360, register selection signals 361 (PCS (2:1)), 363 (PCS (25:21)) and 362 (PCS (15:11)) are generated. If the selection signals 359 (PCS2) and 363 (PCS (25:21)) are High, the data bus 365 is selected via the AND circuit 337, the OR circuit 338 and the data bus 339 and the write signal is inputted to the address counter 323 to set up a transfer destination address.

Furthermore, if the selection signals 358 (PCS1) and 362 (PCS (15:11)) are High, the data bus 365 is selected via the AND circuit 351, the OR circuit 352 and the data bus 353 and the write signal is inputted to the address counter 348 to set up a transfer source address.

In a similar manner, in setting case of a transfer destination address and a transfer source address by means of the CPU 108 in the PDL controller 1, a write signal 349 is inputted from the CPU 108 to the address counters 323 and 348. Besides, by the address bus 340, the bidirectional buffer 341 and the address decoder 344, register selection signals 345 (LCS (2:1)), 346 (LCS (25:21)) and 347 (LCS (15:11)) are generated. If the selection signals 357 (LCS2) and 346 (LCS (25:21)) are High, the data bus 307 in the PDL is selected via the AND circuit 336, the OR circuit 338 and the data bus 339 and the write signal is inputted to the address counter 323 to set up a transfer destination address.

Furthermore, if the selection signals 356 (LCS1) and 347 (LCS (15:11)) are High, the data bus 307 in the PDL is selected via the AND circuit 350, the OR circuit 352 and the data bus 353 and the write signal is inputted to the address counter 348 to set up a transfer source address.

The command data from the printer engine 2 are outputted from the RAM 204 via the PCI address bus 372, the master controller 314, the data bus 311, the buffer FIFO 308, the data bus 306 and the bidirectional buffer 305 to the PDL data bus 303 and stored in the RAM 106. Thereat, a transfer destination address and a transfer source address can be set up by means of the engine CPU 202 and the in-PDL CPU 108, while the case of setup by means of the engine CPU 202 proceeds as follows.

A transfer source address from the RAM 204 is set up by the engine CPU 202 via the PCI address data bus 372, the target controller 371, the data bus 365, the AND circuit 337, the OR circuit 338 and the data bus 339 at an address counter 322 in the DMA controller, further inputted via the address bus 330 to the master controller 314 and outputted from the PCI address bus 372.

Besides, a transfer destination address is set up by the engine CPU 202 via the PCI address data bus 372, the target controller 371, the data bus 365, an AND circuit 351, an OR circuit 352 and the data bus 353 at an address counter 348 and outputted via the data bus 365 and the bidirectional buffer 341 to the address bus 340.

Here, via the command/byte enable signal 374 and a decoder 369, a PCI write signal 370 is generated and inputted to the address counters 323 and 348. Besides, by the PCI address data bus 372, the target controller 371, the address bus 366 and the address decoder 360, register selection signals 361 (PCS (2:1)), 363 (PCS(25:21)) and 362 (PCS (15:11)) are generated. If the selection signals 359 (PCS2) and 363 (PCS (25:21)) are High, the data bus 365 is selected via the AND circuit 337, the OR circuit 338 and the data bus 339 and the write signal is inputted to the address counter 323 to set up a transfer source address.

Furthermore, if the selection signals 358 (PCS1) and 362 (PCS (15:11)) are High, the data bus 365 is selected via the AND circuit 351, the OR circuit 352 and the data bus 353, while the write signal is inputted to the address counter 348 to set up a transfer destination address.

In a similar manner, in setting case of a transfer destination address and a transfer source address by means of the CPU 108 in the PDL controller 1, a write signal 349 is inputted from the CPU 108 to the address counters 323 and 348. Besides, by the address bus 340, the bidirectional buffer 341 and the address decoder 344, register selection signals 345 (LCS (2:1)), 346 (LCS(25:21)) and 347 (LCS (15:11)) are generated. If the selection signals 357 (LCS2) and 346 (LCS (25:21)) are High, the data bus 307 in the PDL is selected via the AND circuit 336, the OR circuit 338 and the data bus 339 and the write signal is inputted to the address counter 323 to set up a transfer source address. Furthermore, if the selection signals 356 (LCS1) and 347 (LCS (15:11)) are True, the data bus 307 in the PDL is selected via the AND circuit 350, the OR circuit 352 and the data bus 353 and the write signal is inputted to the address counter 348 to set up a transfer destination address.

Here, by means of the engine CPU 202 or the CPU 108 of the PDL controller 1, the DMA controller 322 uses either FIFO 308 or 315 respectively via the data bus 365 or 307 to actuate the DMA transfer, sets up which signal of the A and B inputs is selected in response to the selection signal 328 and at the same time turns the DMA REQ signal 334 to be True and outputs it if either the R.WREQ1 signal (310) or the R.WREQ2 signal (326) inputted from the FIFO 308 or 315 is True.

If the DMA REQ signal 334 is True, the CPU 108 is informed via the control signal 332 that the PDL bus arbiter circuit 333 becomes a bus master depending on the status of the control signal 331 inputted from the CPU 108, turns the DOC signal 301 and the ADROC signal 343 to be True, controls the bidirectional buffers 305 and 341 and at the same time turns the DMA ACK signal 335 to be True every time of data transfer in the word unit and outputs it to the DMA controller 322.

On receiving a DMA ACK signal 335 that has become True, the DMA controller 322 turns the R.WACK1 signal (309) or the R.WACK2 signal (325) to be High and outputs it to the FIFO 308 or 315 and at the same time, outputs it also to the address counter 323, 348 to count up the address counters 323 and 348.

In FIG. 2, the R.WREQ1 signal 310 and R.WREQ2 signal 326 and the R.WACK1 signal 309 and R.WACK2 signal 325 are two read signals and two write signals, respectively. In case of data transfer from the RAM 204 in the engine body to the in-PDL RAM 106, every read signal becomes True, whereas every write signal becomes True in case of data transfer from the in-PDL RAM 106 to the RAM 204 in the engine body.

Here, via the AD bus (address bus) 372, the target controller 371 and the address bus 366, the engine CPU 202 can read a value of the configuration register 364 via the data bus 368, the target controller 371 and the AD bus 372 to judge which PDL board is connected.

Also in case of bit map data transfer from the in-PDL RAM 106 to the RAM 204 in the engine body, as with the status data, bit map data are outputted to the PCI address data bus 372 via the PDL data bus 303, the bidirectional buffer 303, the data bus 307, the FIFO 315, the data bus 316, the selector 313 in which the B input is selected in response to the selection signal 328, the data bus 317 and the master controller 314 and transferred to the RAM 204.

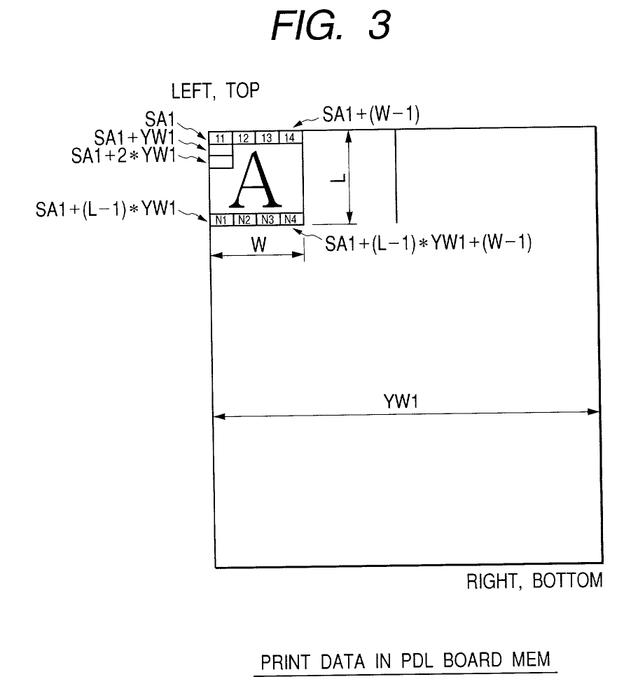

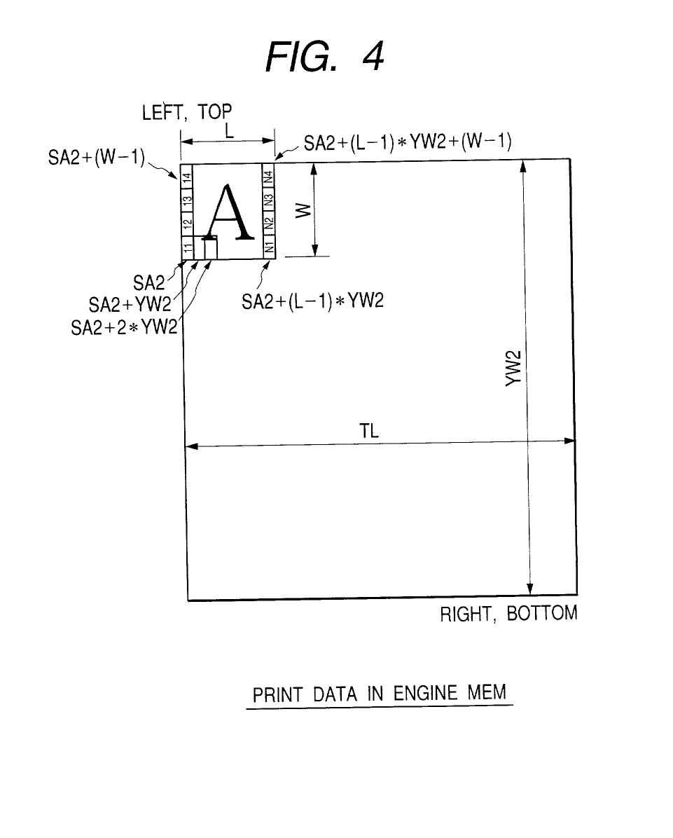

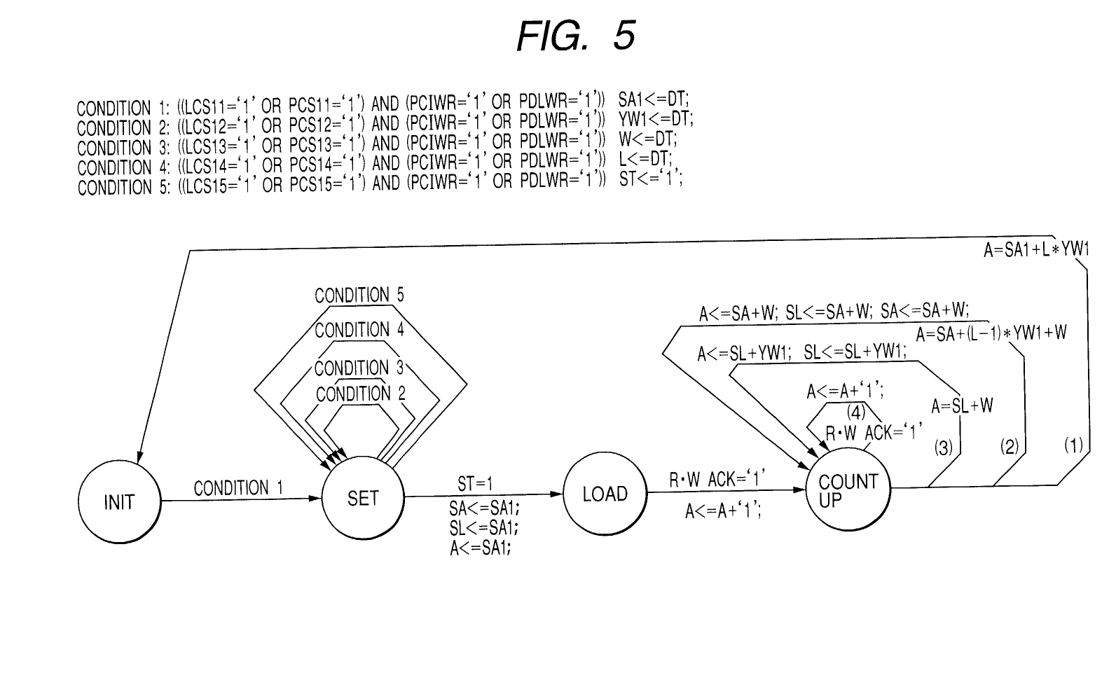

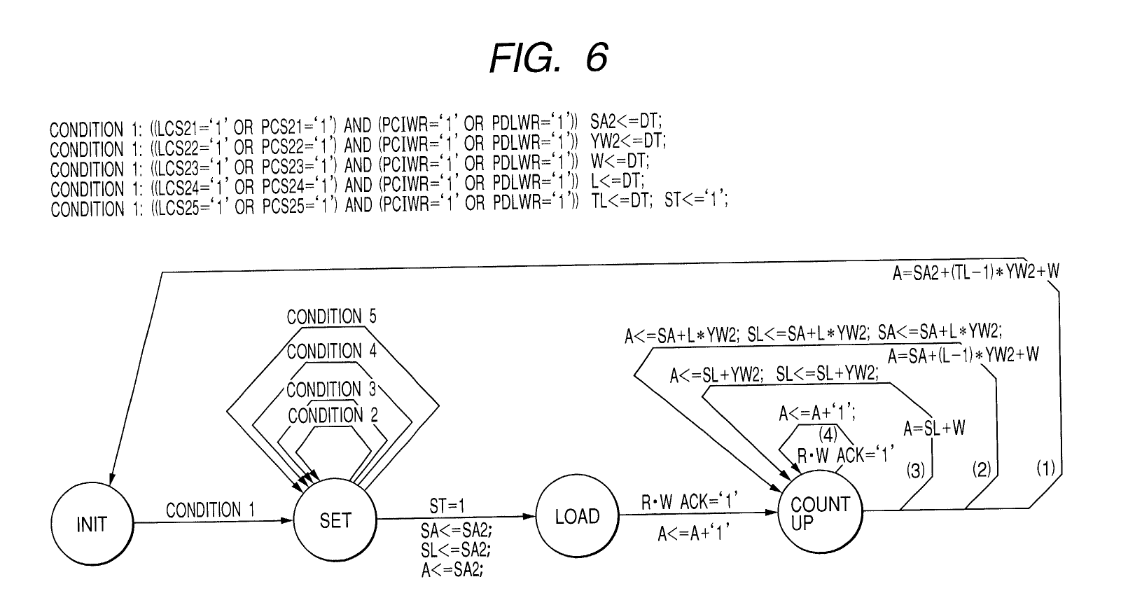

Here, in case of bit map data transfer, as shown in FIGS. 3 and 4, the transfer source top address (SA1) of the rectangular area in which draw data are present, the width (W) of the transfer source rectangular area, the number of lines (L) in the transfer source rectangular area and the transfer source effective print width (YW1) as well as the transfer destination top address (SA2), the width (W) of the transfer destination rectangular area, the number of lines (L) in the transfer destination rectangular area and the transfer destination effective print width (YW2) are set up. These values are set up in the address counters 323 and 348, and the detailed setting method thereof will be described below by using FIGS. 5 and 6.

Incidentally, here, the size of the FIFO 315 as buffer memory is the same as the width W (word) and the number of lines (line) L representing the size of the above rectangular area.

FIGS. 5 and 6 show the status transition of the address counters 348 and 323, respectively, which relates to state machines specifying the operation of the address counters 348 and 323 in synchronism with an unillustrated clock signal. If Condition 1 holds true, the address counter 348, whose initial state is in the state INIT as shown in FIG. 5, sets a value DT of data bus 353 inputted then into the transfer source band top address register (hereinafter, SA1) and proceeds to the SET state. If Condition 2 holds true after the transition to the SET state, the address counter 348 sets a value DT of data bus 353 into the transfer source effective print width register (hereinafter, YW1) and returns to the SET state. Similarly, if Condition 3 holds true, the address counter 348 sets a value DT of data bus 353 into the width register (hereinafter, W) of the transfer source rectangular area, sets a value DT of data bus 353 into the number-of-lines register (hereinafter, L) of the transfer source rectangular area if Condition 4 holds true, turns a value DT of data bus 353 to ‘1’ to set ‘1’ in the state register (hereinafter, ST) if Condition 5 holds true and returns to the SET state. If ST=‘1’ is implemented, the address counter 348 sets a value of SA1 (band top address) into the counter A (address output), the counter SL (line top address) and the counter SA (rectangular area top address) and proceeds to the LOAD state.

If the R.WACK2 signal 325 outputted from the DMA controller 322 is ‘1’, the R.WACK signal 354 inputted via the OR circuit 355 becomes ‘1’, the counter A augments by 1 and the address counter 348 proceeds to the COUNT UP state. Similarly, if the R.WACK signal=‘1’ is implemented, the counter A counts up one by one and the address counter 348 returns to the COUNT UP state. At this time, a value of the counter A is outputted as an address signal 365 of the address counter 348.

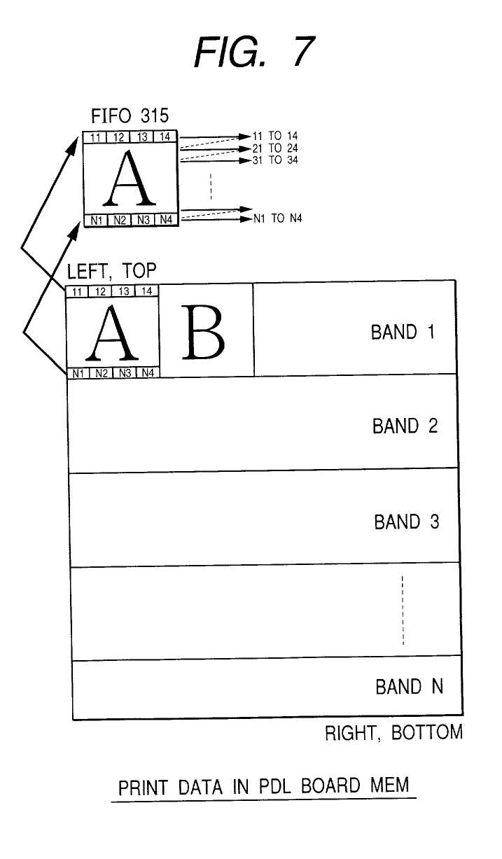

In FIG. 7, in the band 1 of the PDL board memory, the above operation corresponds to an operation of counting up the addresses of the top row, 11 to 14, of the rectangular area in which the character ‘A’ is written using a counter A to read the data in the PDL board memory and writing the readout data into the first row, 11 to 14, of the FIFO 315. Here, if WEN 324 outputted from the DMA controller 322 is True, an address of the FIFO 315 is outputted from the write address counter 318 as an address signal 319 and inputted to the FIFO 315.

In FIG. 5, if a value of the counter A becomes equal to (SL+W) and A=SL+W is implemented, YW1 is added to the counter SL (line top address) and the counter A (address output) and the operation returns to the COUNT UP state, followed by count-up of the counter A. Thereby, the operation returns to the second row of the rectangular area in FIG. 7 and the data of the memories 21 to 24 in the PDL are written in the addresses 21 to 24 of the FIFO 315.

If the WEN 324 is True, an address of the FIFO 315 is outputted from the write address counter 318 as an address signal 319. In a similar manner, this is repeated to the Nth row of the rectangular area in FIG. 7 and the data of the memories N1 to N4 in the PDL are written into the addresses N1 to N4 of the FIFO 315. If the WEN 324 is True, an address of the FIFO 315 is outputted from the write address counter 318 as an address signal 319.

If a value of the counter A becomes equal to (SA+(L−1)*YW1+W) and A=SA+(L−1)*YW1+W is implemented in the COUNT UP state of FIG. 5, the prior (SA+W) is set up in the counter A (address output), the counter SL (line top address) and the counter SA (rectangular area top address) and the operation returns to the COUNT UP state. Thereby, as shown in FIG. 7, the address counter 348 proceeds to the rectangular area designated with ‘B’ in the PDL board memory and an operation similar to the above is repeated.

Furthermore, if a value of the counter A becomes equal to (SA1+L*YW1) and A=SA1+L*YW1 is implemented in FIG. 5, the address counter 348 returns to the INIT state, then SA1, YW1, W, L, ST and so on are set up again and an operation similar to the above is repeated. In FIG. 7, this timing corresponds to a timing of finishing reading all data of the band 1 in the PDL board memory and proceeding to the setting of the band 2.

Incidentally, if a plurality of conditions hold true simultaneously at the COUNT UP state of FIG. 5, the address counter 348 moves to a higher state in the priority sequence according to the priority sequence represented by circle numbers (1) to (4). The circle number (1) is the highest in the priority sequence and the priority sequence lowers with an advance to (4).

On the other hand, the initial state of the address counter 323 is the INIT state as shown in FIG. 6. If Condition 1 holds true, a value DT inputted then of the data bus 339 is set up in the transfer destination band top address register (hereinafter, SA2) and the address counter 323 proceeds to the SET state. If Condition 2 holds true after the transition to the SET state, the address counter sets up a value DT of the data bus 339 in the transfer destination effective print width register (hereinafter, YW2) and returns to the SET state.

As with the above procedure, if Condition 3 holds true, the address counter 348 sets a value DT of data bus 339 into the width register (hereinafter, W) of the transfer destination rectangular area, sets a value DT of data bus 339 into the number-of-lines register (hereinafter, L) of the transfer destination rectangular area if Condition 4 holds true, sets a value DT of data bus 339 into the register for the number of total width scan lines of the transfer destination and sets ‘1’ in the state register (hereinafter, ST) if Condition 5 holds true and returns to the SET state.

And, if ST=‘1’ is implemented, the address counter 348 sets a value of SA2 (band top address) into the counter A (address output), the counter SL (line top address) and the counter SA (rectangular area top address) and proceeds to the LOAD state.

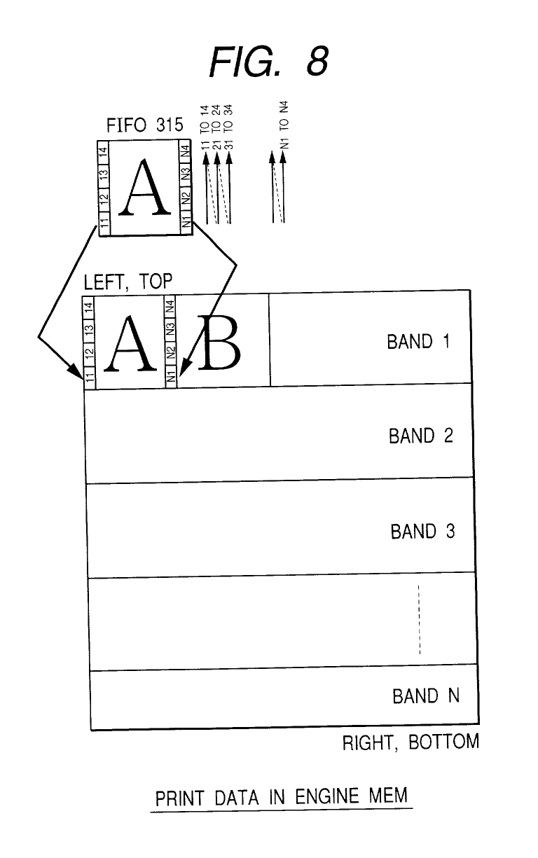

If the R.WACK signal 325 outputted from the DMA controller 322 is ‘1’, the counter A augments by 1 and the address counter 323 proceeds to the COUNT UP state. Subsequently, if the R.WACK signal=‘1’ is implemented, the counter A counts up one by one and the address counter 323 returns to the COUNT UP state. At this time, a value of the counter A is outputted as an address signal 330 of the address counter 323. In FIG. 8, this timing is a timing of counting up the data of 11 to 14 stored in the FIFO 315 by means of the counter A and writing them into the addresses of the top row, 11 to 14, of the rectangular area designated with the character ‘A’ in the band 1 of the engine memory while reading. Here, if REN 327 outputted from the DMA controller 322 is True, an address of the FIFO 315 is outputted from the read address counter 320 as an address signal 321 and inputted to the FIFO 315.

In FIG. 6, if a value of the counter A becomes equal to (SL+W) and A=SL+W is implemented, YW2 is added to the counter SL (line top address) and the counter A (address output), then the operation returns to the COUNT UP state, followed by count-up of the counter A. Thereby, the operation returns to the second row of the rectangular area in FIG. 8 and the data of 21 to 24 of the FIFO 315 are written into the addresses 21 to 24 in the RAM 204 of the printer engine 2.

If the REN 327 is True, an address of the FIFO 315 is outputted from the read address counter 320 as an address signal 321. In a similar manner, this is repeated to the Nth row of the rectangular area in FIG. 8 and the data of the addresses N1 to N4 of the FIFO 315 are written into the addresses N1 to N4 in the engine body memory. If the REN 327 is True, an address of the FIFO 315 is outputted from the read address counter 320 as an address signal 321.

If a value of the counter A becomes equal to (SA+(L−1)*YW2+W) and A=SA+(L−1)*YW2+W is implemented in the COUNT UP state of FIG. 6, the prior (SA+L*YW2) is set up in the counter A (address output), the counter SL (line top address) and the counter SA (rectangular area top address) and the operation returns to the COUNT UP state. Thereby, as shown in FIG. 8, the address counter 323 proceeds to the rectangular area designated with ‘B’ in the engine memory and a similar operation is repeated to write the data in the FIFO 315.

Furthermore, if a value of the counter A becomes equal to (SA2+(TL−1)*YW2+W) and A=SA2+(TL−1)*YW2+W is implemented in FIG. 6, the address counter 323 returns to the INIT state, SA2, YW2, W, TL, L, ST and so on are set up again and a similar operation is repeated. If this is pointed out in FIG. 8, this timing corresponds to a timing of finishing writing all data in the FIFO 315 into the band 1 in the engine memory and proceeding to the setting of the band 2.

Incidentally, if a plurality of conditions hold true simultaneously at the COUNT UP state of FIG. 6, the address counter 348 moves to a higher state in the priority sequence according to the priority sequence represented by circle numbers (1) to (4). The circle number (1) is the highest in the priority sequence and the priority sequence lowers with a progress to (4).

And, as shown in FIG. 8, the assignment method of addresses in the RAM 204 of the printer engine 2 is the 90° rotation of that in the PDL board memory and the address assignment method in the case of readout from the FIFO 315 becomes the 90° rotation of the address assignment method in that of write into the FIFO 315.

Thus, at the side of the printer engine 2, no further rotation processing is performed and only by reading data from the RAM 204 simply and inputting them into the printer 206 via the printer I/F 205, an image of A4 sheet can be outputted to an A4 transverse sheet. Needless to say, the image generator 105 at the side of the PDL controller 1 also needs no image rotating processing at the image developing time of a great processing cost.

As described above, according to First Embodiment, the transfer source top address (SA1) of the rectangular area in which draw data are present, the width (W) of the transfer source rectangular area, the number of lines (L) in the transfer source rectangular area and the transfer source effective print width (YW1) as well as the transfer destination top address (SA2), the width (W) of the transfer destination rectangular area, the number of lines (L) in the transfer destination rectangular area, the number of total width scan lines of the transfer destination, and the transfer destination effective print width (YW2) can be set up from the engine body and from inside the PDL and are selected from PCS (15:11) 362 and PCS (25:21) 363 as well as LCS (15:11) 347 and LCS (25:21) 346, respectively.

To be specific, in the case of data transfer of draw data in the PDL board memory RAM 106 to the memory RAM 204 in the engine body, the rotation of on-sheet data is carried out during the DMA transfer by writing the data into the FIFO via the FIFO 315 as a rectangular buffer memory, rotating the readout direction at an angle of 90° and writing the data into the engine memory also after the 90° rotation, so that no need for the developing processing accompanying the rotation of an image when the image generator 105 of the PDL controller 1 develops the bit map data on the RAM 106 enables a decrease in developing capability due to the rotating function to be prevented and a high-speed printing to be performed without a decrease in throughput.

Second Embodiment

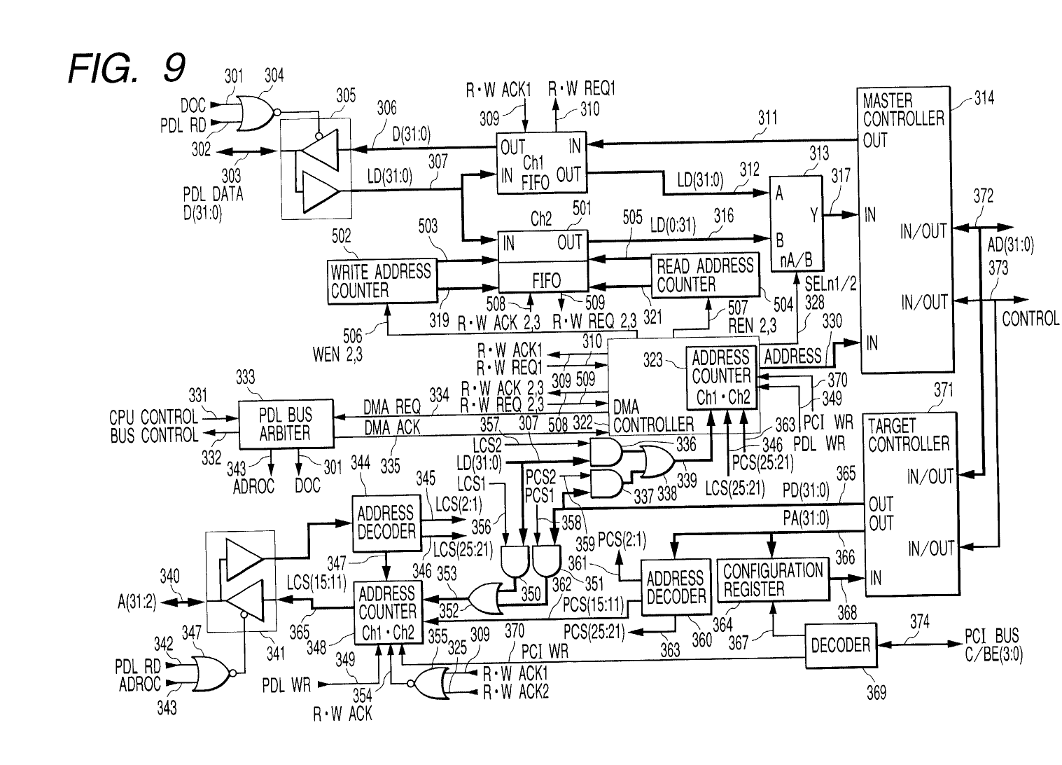

FIG. 9 shows Second Embodiment of the present invention. The arrangement of FIG. 9 is an arrangement that two rectangular area buffer memories are provided and two FIFOs 315 of FIG. 2 are unitized into a single FIFO 501 (FIFO 501-1 and FIFO 501-2). In FIG. 9, identical reference numerals are attached to blocks identical or corresponding to those of Second Embodiment and the description thereof is to be omitted.

In the case of FIG. 2, the data in the FIFO 315 cannot be transferred to the RAM 204 of the printer engine 2 till the write into the FIFO 315 ends, but the arrangement of FIG. 9 permits the data in the PDL board memory to be written into the FIFO 501 while transferring data from the FIFO 501 to the engine memory.

In FIG. 9, in the case of draw data transfer from the RAM 106 in the PDL controller 1 to the in-engine RAM 204, the method of setting into the address counters 348 and 323 is the same, but the data in the PDL board memory are first written into the FIFO 501-1 of the first part in the FIFO 501 by the same method as with FIG. 2. Next, when writing the data of the FIFO 501-1 into the engine memory, the data in the PDL board memory are written into the FIFO 501-2 of the second part in the FIFO 501. Furthermore, while the data in the FIFO 501-2 are written into the engine memory, the data in the PDL board memory are so arranged as to be written into the FIFO 501-1.

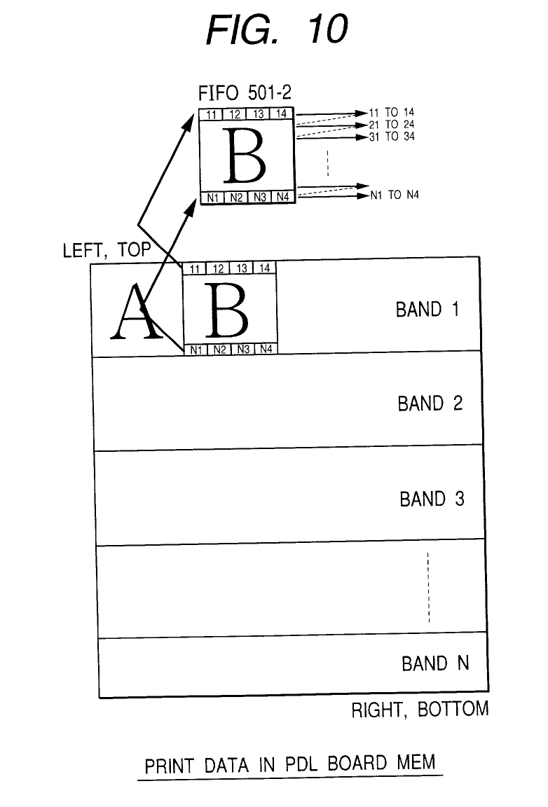

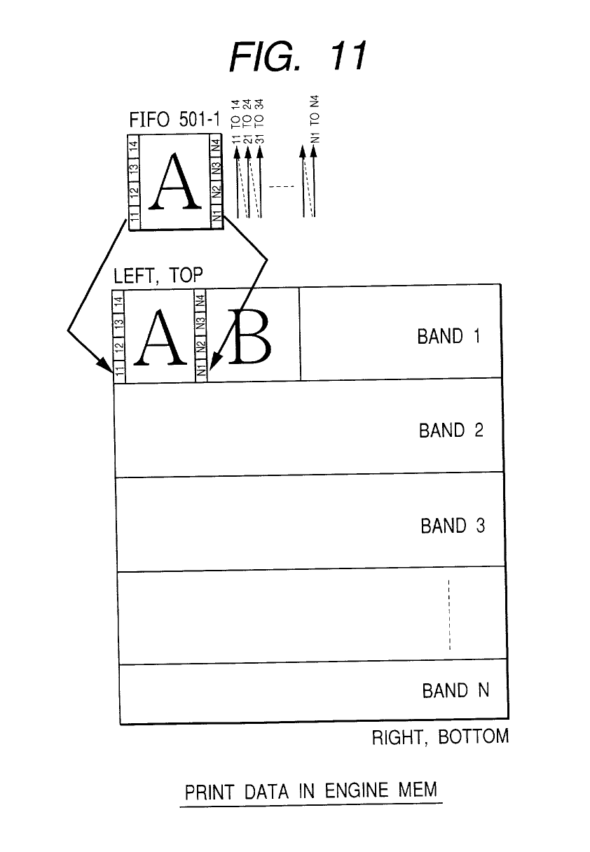

FIGS. 10 and 11 show the operation in the arrangement of FIG. 9. To be specific, when the character of the rectangular area ‘A’ within the PDL board memory in FIG. 10 is written into the FIFO 501-1 and the character of the rectangular area ‘B’ is written into the FIFO 501-2, data in the FIFO 501-1 are written into the rectangular area designated with ‘A’ within the engine memory as shown in FIG. 11. Similarly, when the data of the subsequent rectangular area within the PDL board memory are written into the FIFO 501-1, the data in the FIFO 501-2 are written into the rectangular area designated with ‘B’ within the engine body memory and this operation is repeated as shown in FIG. 11.

Write addresses of the FIFO 501-1 and the FIFO 501-2 in FIG. 9 are inputted as address signals 319 and 503 outputted from the write address counter 502. If the WEN 2 outputted from the DMA controller 322 is True, a write address signal 319 counts up, whereas a write address signal 503 counts up if the WEN 3 outputted from the DMA controller 322 is True.

Read addresses of the FIFO 501-1 and the FIFO-2 are inputted as address signals 321 and 505 outputted from the read address counter 504. If the REN 2 outputted from the DMA controller 322 is True, a read address signal 321 counts up, whereas a read address signal 505 counts up if the REN 3 outputted from the DMA controller 322 is True.

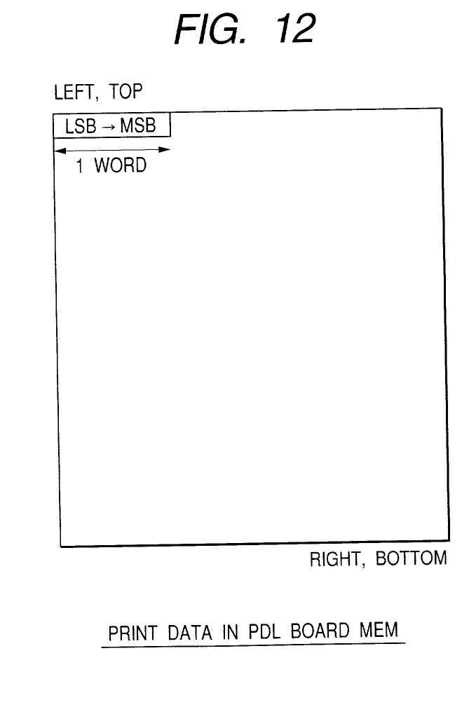

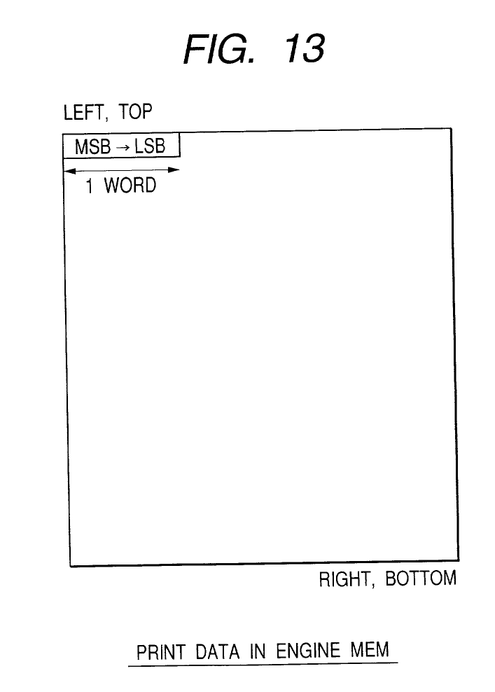

Incidentally, if the sequence arrangement of bit map data in the PDL and data in the engine are opposed to each other as shown in FIGS. 12 and 13, the data bus 307 LD (31:0) to be inputted into the FIFOs 315 and 501 and the data bus 316 LD (0:31) to be outputted from the FIFOs have only to be made opposite in sequence arrangement and to be connected as shown in FIGS. 2 and 9.

As a matter of course, if the sequence arrangement of bit map data in the PDL and data in the engine are identical, the data bus to be inputted into the FIFOs 315 and 501 and the data bus to be outputted from the FIFOs have only to be connected in the same sequence arrangement and an effect similar to that of First Embodiment is exhibited.

As mentioned above, by constructing the FIFO 501 as multiple buffer memories, data in the PDL board memory can be written into the FIFO 501 while transferring data from the FIFO 501 into the engine memory RAM 204 of the printer engine 2, and further the transfer efficiency of image data can be improved, thereby enabling a high-speed printing to be executed.

Third Embodiment

In Second Embodiment, an arrangement that two FIFOs are provided to simultaneously execute the read and write is shown, but much the same effect can be obtained also by contriving an access to the FIFO.

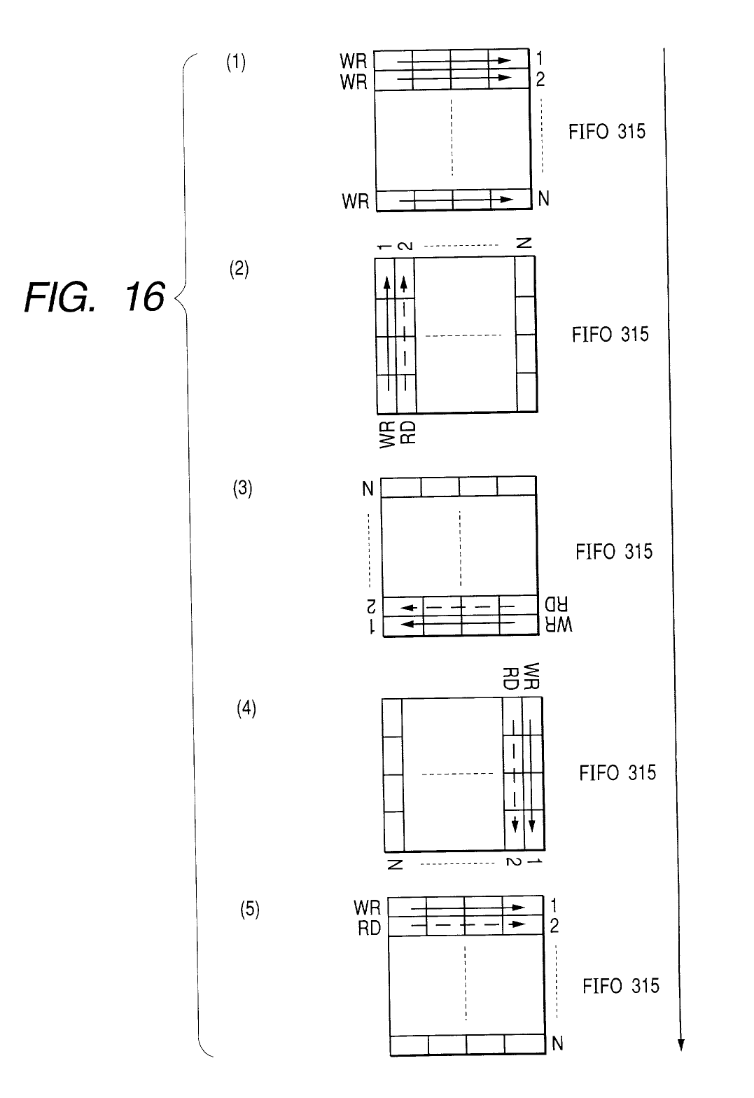

Here, a description will be made on the basis of the arrangements of FIGS. 1 to 8 in First Embodiment. FIG. 16 shows a method of making a write/read access to the FIFO 315 in this embodiment.

With this embodiment, after data are written from the first row to the Nth row of the FIFO 315 as shown in (1) of FIG. 16, one row is read from the 90° rotating direction of the FIFO 315 and thereafter the next data are written into the first row while reading the second row as shown in (2) of FIG. 16. Similarly after this, the next data are written into the (L−1)th row while reading the Lth row and similar operations are repeated till the Nth row.

Furthermore, after one row is antecedently read from a further 90° rotating direction of the FIFO 315, the next data are written into the previous row while the first following row is read as shown in (3) of FIG. 16, similar operations are repeated till the Nth row and the procedure proceeds to (4) and (5) of FIG. 16.

As mentioned above, by executing the write into the area in which the read is completed, the write and read to the FIFO 315 can be multiplexed.

In the following, it will be specifically shown how to transfer image data according to a transfer scheme as mentioned above.

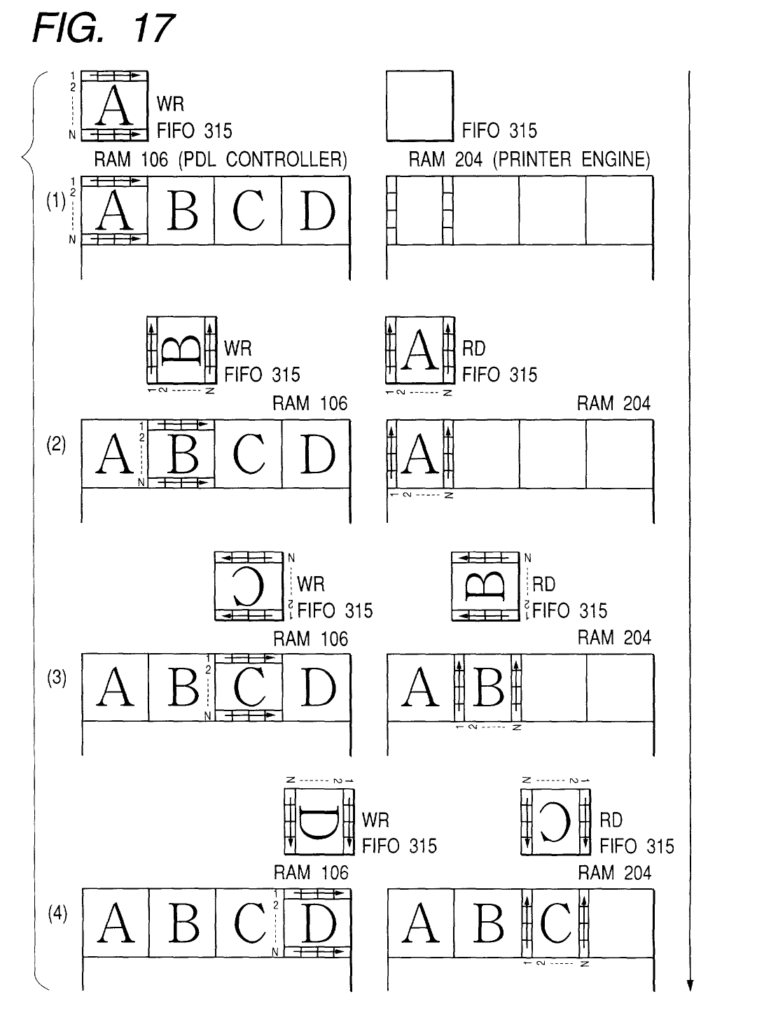

FIG. 17 shows a method of writing the data read out from a RAM 106 within a PDL controller into the FIFO 315 and a method of storing the image data read out from the FIFO 315 into a RAM 204 within a printer engine. In (1) of FIG. 17, when the data of the RAM 106 within the PDL controller are written into the FIFO 315 in the sequence ordering from the first row to the Nth row, the character “A” developed on the RAM 106 within the PDL controller is written into the FIFO 315.

Next, in (2) of FIG. 17, after one row is read out from the 90° rotating direction of the FIFO 315 and one row is written into the RAM 204 within the printer engine, the next data are written from the RAM 106 within the PDL controller into the first row of the FIFO 315 while the second row is read out from the FIFO 315 and stored into the RAM 204 within the printer engine.

Similarly, after this, the data of the RAM 106 within the PDL controller are written into the prior row of the FIFO 315 while the next row is read out from the FIFO 315 to the RAM 204 of the printer engine. By repeating these, the data “B” of the RAM 106 within the PDL controller are written into the FIFO 315 while the data “A” in the FIFO 315 are written into the RAM 204 within the printer engine.

Next, in (3) of FIG. 17, while the data “B” are read out from a further 90° rotating direction of the FIFO 315 to the RAM 204 within printer engine, the data “C” are written from the RAM 106 within the PDL controller into the FIFO 315. Similarly, after this, in (4) of FIG. 17, while the data “C” are read out from a still further 90° rotating direction of the FIFO 315 to the RAM 204 within printer engine, the data “D” are written from the RAM 106 within the PDL controller into the FIFO 315.

As mentioned above, even if the FIFO 315 is one buffer memory, the mutiplexing of write and read to the FIFO 315 enables the image data transfer and the image data rotation to be executed efficiently and moreover to be improved to the transfer rate equal to that of an arrangement using multiple buffer memories, thereby making the memory-saving and the cost-down possible.

Fourth Embodiment

As mentioned above, there are cases where the 90° rotation of image data occasionally becomes unnecessary. For example, in the case of printing on an A4 transverse sheet, 90° rotated image data must be used, but a case where the A4 transverse sheets in a cassette are used up and printing is made using an A4 longitudinal sheet for emergency measures comes under this.

In this embodiment, depending on whether the presence or the absence of A4 transverse sheets and A4 sheets in a sheet cassette, data transfer accompanying the 90° rotation of image data and data transfer without the 90° rotation are switched. Also in this embodiment, the hardware configuration is to be made equal to that of FIG. 1 to 8 in First Embodiment. Besides, since the presence of sheets in the sheet cassette has only to be detected using a publicly-known optical sensor or the like, a detailed description is to be omitted here.

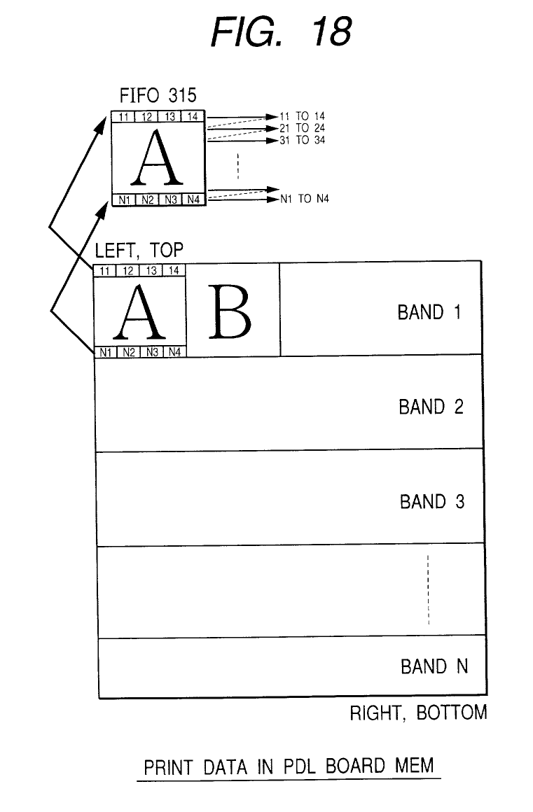

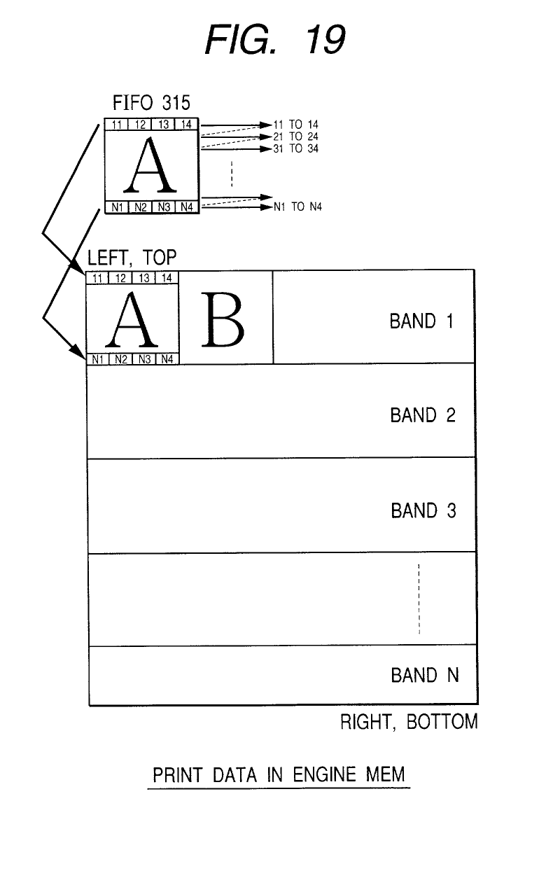

With this embodiment, in the case of printing on an A4 sheet with A4 transverse sheets present in the sheet cassette, as mentioned above, data transfer accompanying the 90° rotation of image data (FIGS. 3 and 4) is carried out, whereas data transfer without the 90° rotation is carried out as shown in FIGS. 18 and 19 if the A4 transverse sheet is absent and A4 longitudinal sheets are present in the sheet cassette.

At this time, the CPU 202 of the printer engine informs the DMA controller 322 of no rotation at the data transfer time via a PCI address data bus 372, a target controller 371, a data bus 365, an AND circuit 337, an OR circuit 338 and a data bus 339 and controls the method of write into and that of read from the FIFO 315 so as to become identical thereby.

Namely, write from the memory 106 within the PDL controller into the FIFO 315 is performed as shown in FIG. 18 and write from the FIFO 315 into the memory 204 within the printer engine is performed as shown in FIG. 19.

In this case, the transfer destination top address (SA2), the width (W) of the transfer destination rectangular area, the number of lines (L) in the transfer destination rectangular area and the transfer destination effective print width (YW2) are set up like the transfer source top address (SA1) of the rectangular area in which picture data are present, the width (W) of the transfer source rectangular area, the number of lines (L) in the transfer source rectangular area and the transfer source effective print width (YW1), while the address counter 323 is counted up like the address counter 348.

Besides, the information about the presence of A4 sheets in the printer engine can be also so arranged as to be notified to the PDL controller 1. In this case, since the DMA controller 322 can be established from the CPU 108 of the PDL controller so as not to be rotated at the data transfer time, a useless rotation processing can be omitted.

Besides, the transfer was controlled for each rectangular area above, but no such rotation is always required.

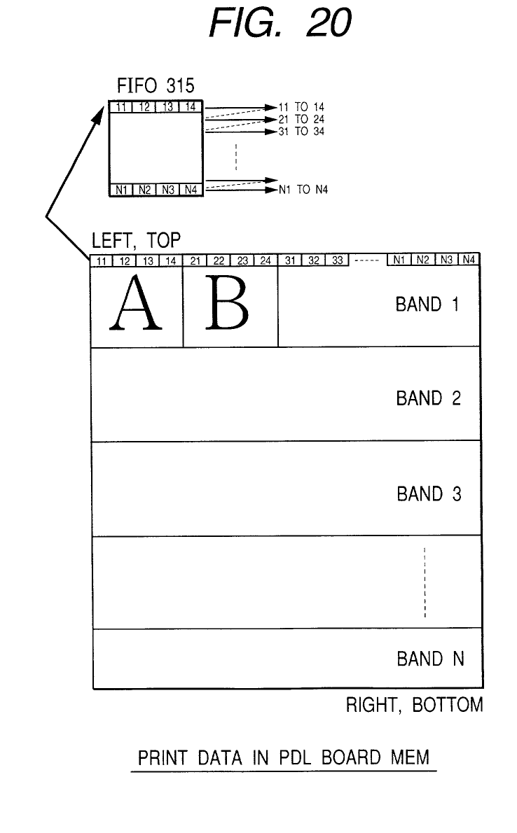

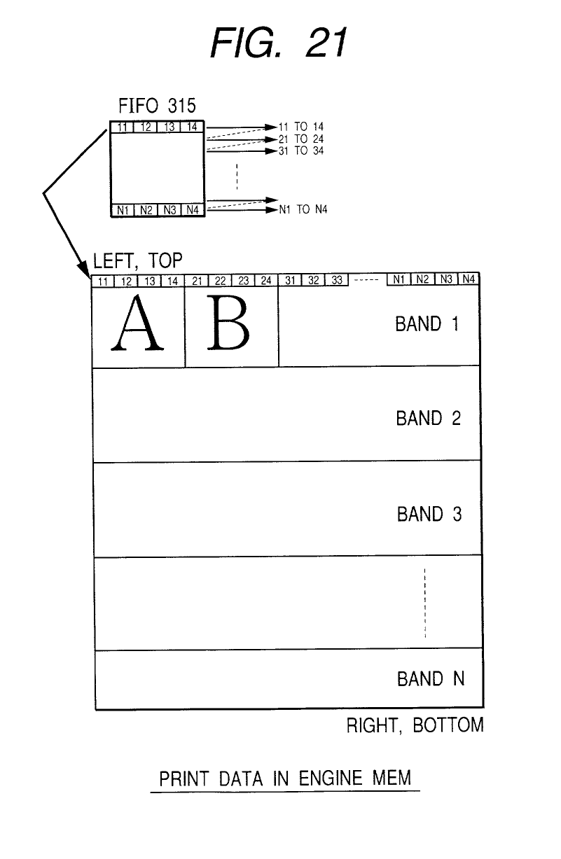

As shown in FIGS. 20 and 21, for example, when no A4 transverse sheet is present and rotation is unnecessary at the data transfer time, data are not written into the FIFO 315 for each rectangular area but may be for each line of the main scanning direction from the memory 106 within the PDL controller into the FIFO 315 and also from the FIFO into the memory 204 within the printer engine for each line of the main scanning direction.

In this case, the CPU 202 of the printer engine sets up only the top address in the address counters 323 and 348 for each band and both counters have only to count up linearly. Needless to say, also in this arrangement, if the information about the presence of A4 sheets in the printer engine is notified to the PDL controller 1, the useless rotation processing can be omitted because the CPU 108 of the PDL controller can set up only the top address in the address counters 323 and 348 for each band.

Incidentally, as with the above-mentioned embodiments, if bit map data in the PDL and data in the engine are opposed in sequence arrangement to each other as shown in FIGS. 12 and 13, the data bus 307 LD (31:0) to be inputted into the FIFO 315 and the data bus 316 LD (0:31) to be outputted from the FIFO have only to be made opposite in sequence arrangement and to be connected.

As a matter of course, if the sequence arrangement of bit map data in the PDL and data in the engine are identical, the data bus to be inputted into the FIFO 315 and the data bus to be outputted from the FIFO have only to be made identical in sequence arrangement and to be connected, and an effect similar to that of the above-mentioned embodiment is expectable.

Besides, in the above-mentioned embodiments, N×M bit FIFO 315 was used also in case of no need for rotation at the time of data transfer from the RAM within the PDL controller to the RAM within the printer engine body, but even a small memory on the order of N×2 bits is available and an effect similar to that of the above-mentioned embodiment is expectable.

As mentioned above, even if the FIFO 315 comprises one buffer memory, since the developed data can be rotated at the time of data transfer from the PDL controller to the printer engine by allowing the read from the FIFO 315 to precede and writing the data of the RAM 106 within the PDL controller into the FIFO 315 while reading data from the FIFO 315 to the RAM 204 of the printer engine 2, a decrease in performance due to the rotation at the data developing time can be prevented. Besides, since based on the information about the presence of sheets in the engine body, it can be controlled whether the developed data are rotated or not at the time of data transfer from the PDL controller to the printer engine, a useless rotation in the engine body can be deleted, for example, when transverse sheets are used up or the like.

In brief, according to Fourth Embodiment, the rotation of an image is performed without a decrease in the throughput of a printer, thus permitting high-speed printing, and moreover the information about the presence of sheets in the engine body is obtained to make a control so that no useless rotation is done, thereby enabling the transfer efficiency to be improved equal to that of an arrangement using multiple buffer memories (e.g. Second Embodiment) and further the memory-saving and the cost-down to be achieved.

Besides, normally, bit map data are generated in the image generator 104 in the form of A4 transverse sheets as that of sheets on which to print data and outputted to the printer engine 2 without rotation at the PCI I/F 109, while when A4 transverse sheets are used up and print is made on an A4 longitudinal sheet, bit map data can be generated in the image generator 104 in the form of A4 transverse sheets as that of sheets on which to print data and outputted to the printer engine 2 also after the rotation at the PCI I/F 109.

Fifth Embodiment

With this embodiment, among the print data inputted from an external apparatus, commands/status data or letter data made of character codes are transferred from a memory in a PDL controller via a PCI controller to a memory in a printer engine by using a common bus, whereas image data, i.e. bit map data developed by means of the PDL controller, are transferred using no common bus but a dedicated bus.

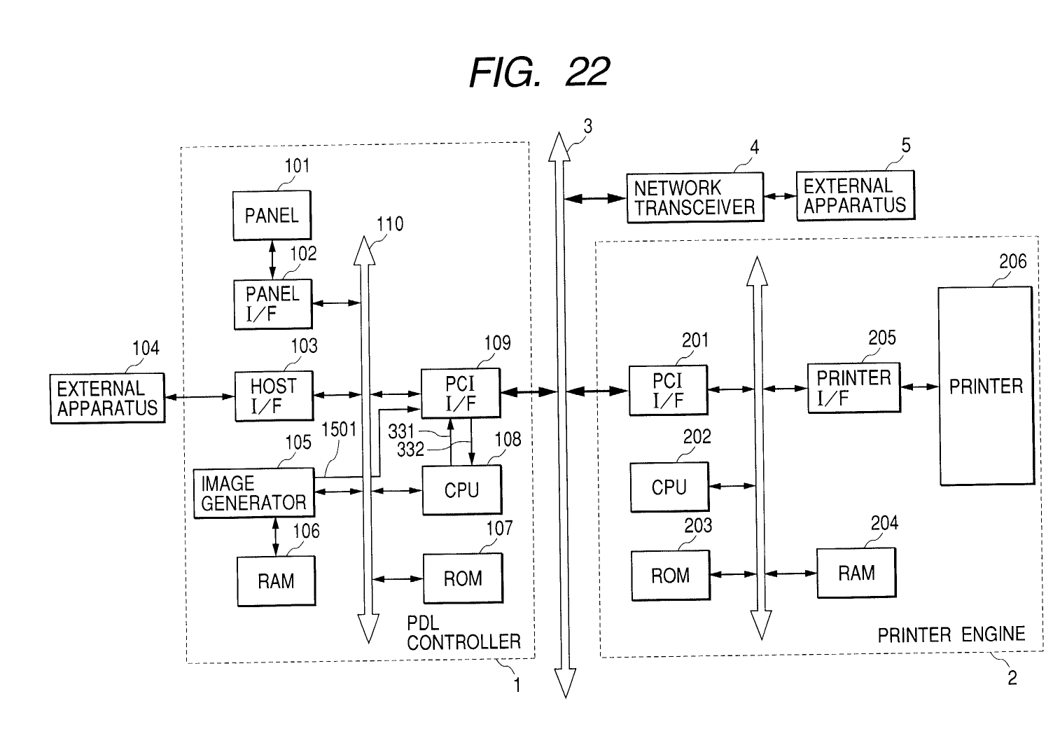

FIG. 22 shows the configuration of a printing system according to this embodiment. FIG. 22 is a drawing similar in configuration to FIG. 1 of First Embodiment and represents the configuration of connecting the PDL controller 1 and the printer engine 2 by using a PCI bus 3. In FIG. 22, like reference numerals are attached to parts common to those of FIG. 1 and detailed description thereof is to be omitted.

FIG. 22 differs from FIG. 1 in the structure surrounding an image generator 105, a RAM 106 and a PCI I/F 109.

To be specific, in FIG. 22, the image generator 105 develops the print data of PDL type received from the host I/F 103 and writes the bit map data into the RAM 106 as with First Embodiment. In addition to image data generating means, the image generator 105 includes a RAM controller also and can store the commands/status data of RAM 204 of the printer engine 2 into the RAM 106.

In this embodiment, as with FIG. 1, the commands/status data from the printer engine 2 are transferred from the RAM 204 to the RAM 106 via PCI controllers 201 and 109 and an image generator 105.

Besides, in this embodiment, the bit map data developed at the PDL controller 1 are developed from the RAM 106 via the image generator 105, a dedicated bus 1501, the PCI controllers 109 and 201 to the RAM 204 within the printer engine.

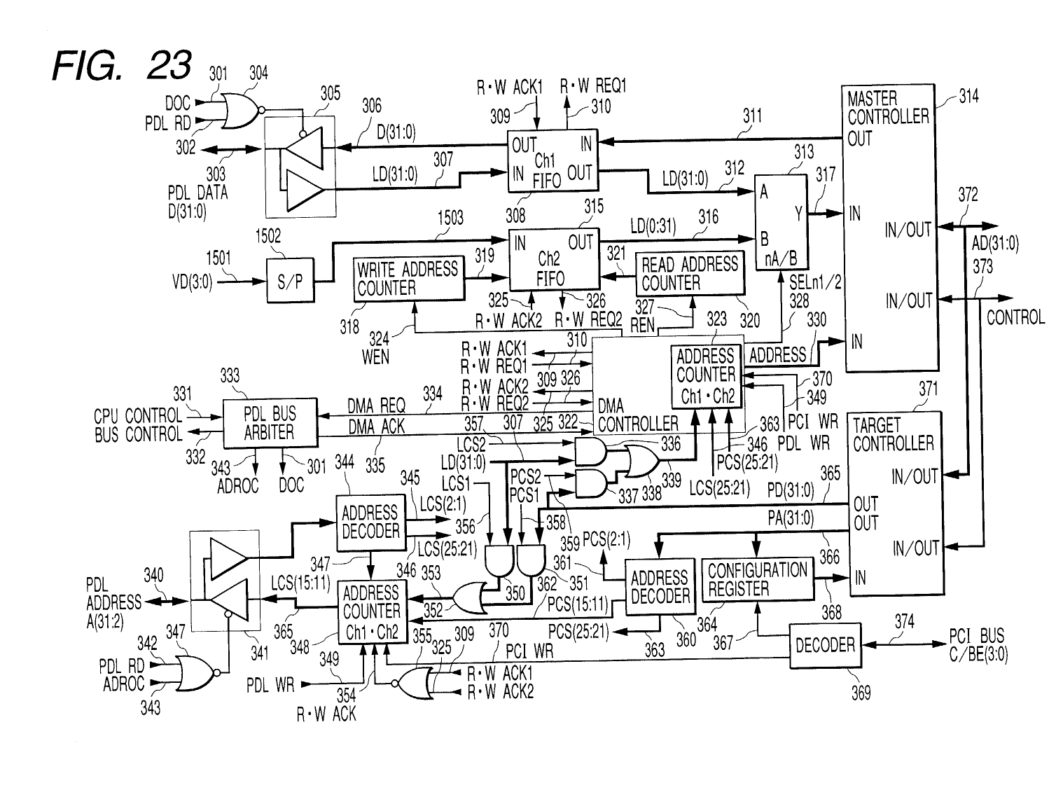

FIG. 23 corresponds to FIG. 2 of First Embodiment and shows the internal structure of the PCI controller 109 of FIG. 22 in detail. In FIG. 23, like reference numerals are attached to parts common to those of FIG. 2 and detailed description thereof is to be omitted.

FIG. 23 differs from FIG. 2 in that the bit map data developed at the PDL controller 1 are so arranged as to be transferred via the dedicated bus 1501.

To be specific, when transferred from the RAM 106 of the PDL controller 2 to the RAM 204 within the engine body in FIG. 23, the bit map data are converted via the dedicated bus 1501 (VD (3:0)) and a serial-parallel converter 1502 into 32-bit data and inputted via a data bus 1503 to the FIFO 315. The route after the FIFO 315 is similar to that of FIG. 1 and the data are outputted via a data bus 316, a selector 313 in which the B input is selected in response to a selection signal 328, a data bus 317 and a master controller 314 to a PCI address data bus 372, then transferred to the RAM 204.

This embodiment differs from First to Fourth Embodiments only in that bit map data are transferred from the RAM 106 of the PDL controller 2 to the FIFO 315 by using the dedicated bus 1501, while transfer accompanying 90° rotation like First to Third Embodiments or transfer without 90° rotation like Fourth Embodiment can be implemented like FIGS. 3 to 8 (or FIGS. 16 and 17 or FIGS. 18 to 21) as mentioned above.

And, according to this embodiment, in the PDL controller 1, since letter data from an external apparatus and commands/status data inputted from/outputted to the printer engine 2 are transferred via the RAM 106, a bus 110 and the PCI controller 109 but the developed bit map data are transferred from RAM 106 via the image generator 105, the dedicated bus 1501 and the PCI controller 109, the bus 110 is not occupied at the bit map data transfer time and other devices can operate even for a great amount of bit map data and further input/output of commands/status data is not badly affected, thereby enabling the performance of print processing to be prevented from deterioration. In particular with the configuration of this embodiment, since an access of the CPU 108 to the RAM 107 or the RAM 106 becomes possible during the transfer of bit map data, the parts providing a bottle neck in performance can be avoided and high-speed printing is performable.

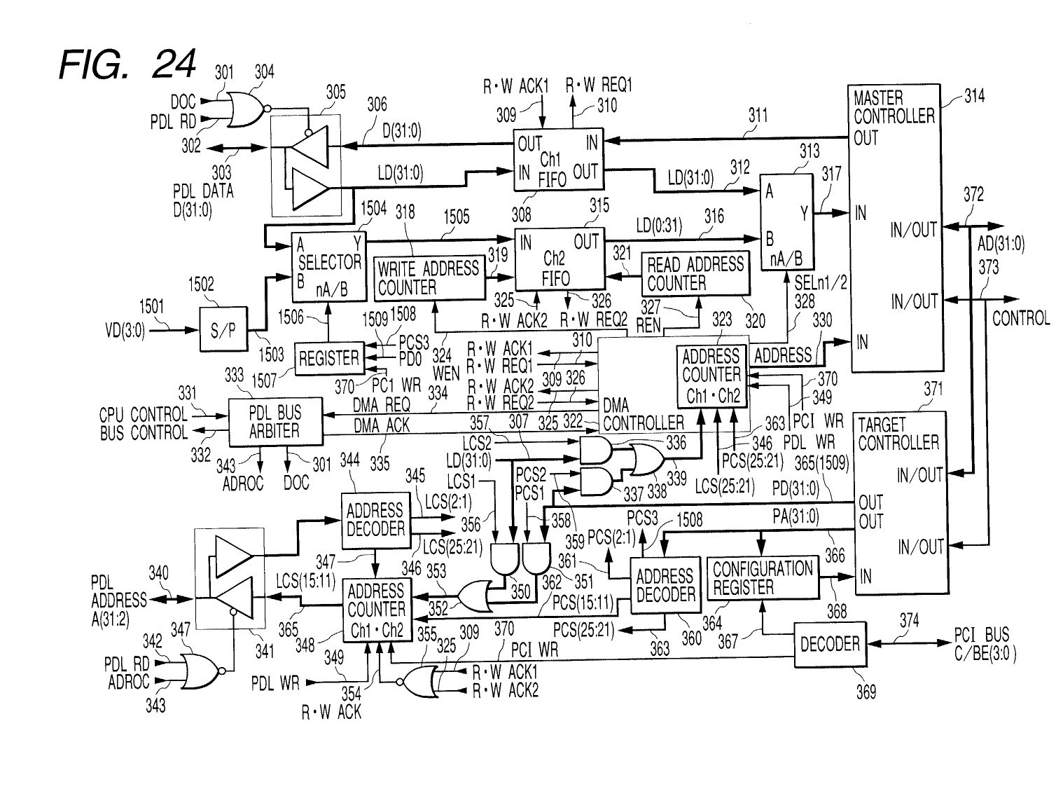

Incidentally, FIG. 23 shows the arrangement of inputting image data solely via the dedicated bus 1501 to FIFO 315, but as shown in FIG. 24, an arrangement allowing data inputted from the side of a bidirectional buffer 305 to be-also inputted as shown in FIG. 24 can be considered.

To be specific, in FIG. 24, the input route of bit map data can be selected out of either a route comprising the dedicated bus 1501-the serial/parallel converter circuit 1502 for the conversion into 32-bit data-the data bus 1503 or a route comprising the data bus 303-the bidirectional buffer 305-the data bus 307 like First Embodiment. Either of the above routes (data bus 1503 or data bus 307) is selected by the selector 1504 directly prior to the FIFO 315.

The selection signal 1506 for controlling the selector 1504 is set up by the CPU 202 (or CPU 108 at the side of the PDL controller is available), but at that time, first, a PCI data selection signal 1508 is prepared from an AD bus (address bus) 372, a target controller 371, an address bus 366 and an address decoder 360 and inputted to a register 1507. Besides, data 1509 (PCI side data) derived from part of the route comprising the AD bus 372, the target controller 371 and data bus 365, and a command/byte enable signal 374 and a PCI write signal 370 generated via the decoder 369 are inputted to the register 1507 to prepare a selection signal 1506 and thus either data bus 1503 or 307 is selected.

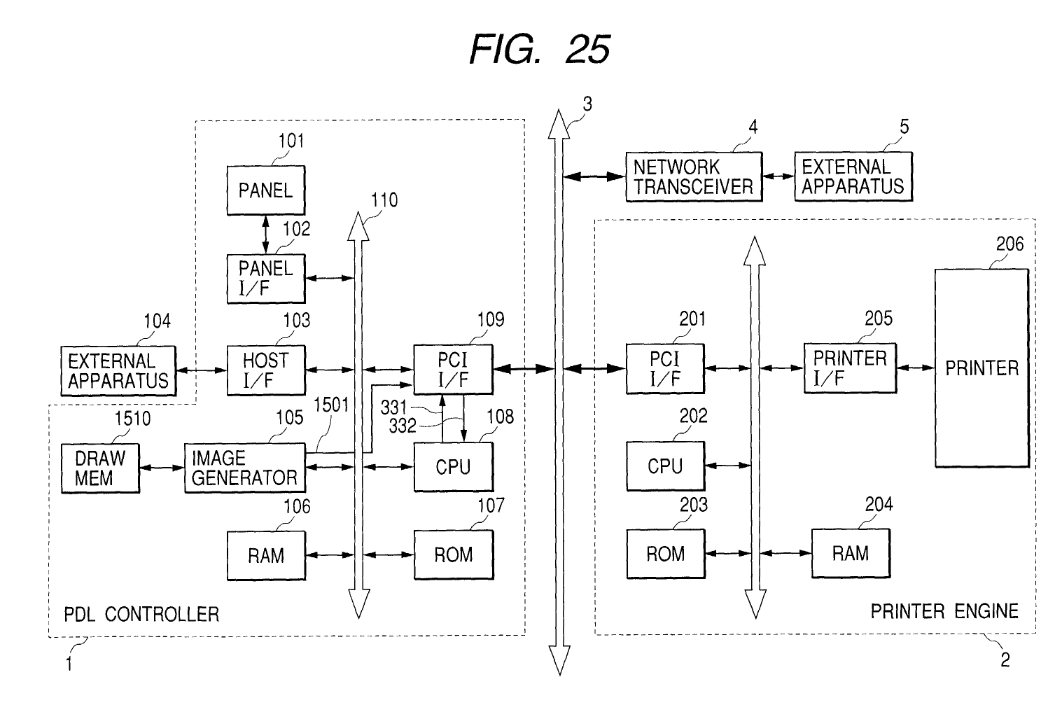

Besides, in FIG. 22, image data were to be stored into the RAM 106, but the provision configuration of a dedicated draw memory 1510 is also considered as shown in FIG. 25.

In FIG. 25, a dedicated memory 1510 for drawing is connected to the image generator 105 and the developed data generated by the image generator 105 are stored into the draw memory 1510. When transferred to the RAM 204 of the printer engine, the bit map data are transferred to the RAM 204 via the draw memory 1510, the image data generator 105, the bus 501 and the PCI controllers 109 and 201. Besides, the RAM 106, into which letter data transferred from the external apparatus 104 or the like is stored, is used also as a work area for operating a program.

By making the draw memory 1510 independent in such a manner, the separation of busses between image data and other commands/status data is enhanced and the effect of improvement toward a higher throughput can be expected.

Incidentally, also in this embodiment, if the sequence arrangement is opposite between the bit map data within the PDL and the data within the engine, LD (31:0) in the data bus 505 to be inputted into the FIFO 315 and LD (0:31) in the data bus 316 to be outputted from the FIFO have only to be made opposite in sequence arrangement and to be connected as shown in FIGS. 12 and 13.

Besides, in this embodiment, the dedicated bus 1501 is a 4-bit wide data bus, but is allowable to be of another bit width, such as 1, 2, 8, 16 and 32 bit width, which manifests a similar effect to the above embodiment. Incidentally, if the dedicated bus 1501 is of 32-bit width, it is needless to say that no serial/parallel converter circuit 1502 is necessary.

As described above, according to the present invention, adopted in a printer with a PDL controller and a printer engine constructed in a predetermined recording scheme connected using a parallel interface for the DMA transfer of image data to be printed via the interface and a control method thereof is an arrangement of writing the draw data developed in the PDL controller once into a buffer memory, reading the 90° rotated data from the buffer memory and making a DMA transfer to a memory of the printer engine, thereby bring about an effect that by rotating the draw data in transferring the bit map data from the RAM within the PDL controller to the RAM within the printer engine without rotation of an image at the image developing time of the PDL controller, a decrease in developing capability due to the rotation at the image developing time of the PDL controller is prevented, image rotation is carried out without a decrease in the throughput of the printer, and high-speed printing is performable.

What is claimed is:

1. A printer in which a PDL controller and a printer engine made up in a predetermined recording scheme are connected with each other by using a parallel interface for DMA-transferring image data to be printed via said interface, comprising:
control means for writing draw data developed in said PDL controller once into a buffer memory, reading the 90° rotated data from said buffer memory and making a DMA transfer to a memory of said printer engine.

2. The printer according to claim 1, wherein draw data are divided into predetermined rectangular areas having the size of said buffer memory and for each of said rectangular areas, a top address of said rectangular area of a memory in the PDL controller, an effective print area width, the width of said rectangular area, the number of lines in said rectangular area or a transfer size as well as a top address of said rectangular area of a memory in said printer engine, an effective print area width, the width of said rectangular area, the number of lines in said rectangular area or a transfer size are set up to make a DMA transfer.

3. The printer according to claim 1, wherein said buffer memory has an N×M bit size, N corresponds to a positive integer times the size of the data bus at the PDL controller side and M corresponds to a positive integer times the size of the data bus at the printer engine.

4. The printer according to claim 3, wherein a plurality of said buffer memories of N×M bit size are provided to write draw data from a memory within the PDL controller into one buffer memory and at the same time, read data from another buffer memory and write the data into a memory of the printer engine.

5. The printer according to claim 1, wherein the draw data developed in said PDL controller are once written into an N×M bit and single buffer memory, the 90° rotated data are read from said buffer memory and the next draw data are written into said buffer memory while the data to be transferred from said buffer memory to said printer engine memory are read in the DMA transfer to said printer engine memory.

6. The printer according to claim 1, wherein the draw data developed in said PDL controller are once written into a buffer memory and read out from said buffer memory and it is controlled corresponding to predetermined processing conditions whether 90° rotation of said data is executed or not in the DMA transfer to said printer engine memory.

7. The printer according to claim 6, wherein said predetermined processing conditions comprise the presence of respective like-sized sheets having different print directions and it is controlled corresponding to said predetermined processing conditions whether 90° rotation of said data is executed or not.

8. A printer according to claim 1, wherein the draw data developed in said PDL controller are transferred to said buffer memory via a dedicated bus different from a common bus for transferring other data than draw data between said PDL controller and the printer engine.

9. A method for controlling a printer, in which a PDL controller and a printer engine made up in a predetermined recording scheme are connected with each other by using a parallel interface for DMA-transferring image data to be printed via said interface, the method comprising the steps of: writing the draw data developed in said PDL controller once into a buffer memory; reading the 90° rotated data from said buffer memory; and making a DMA transfer to a memory of said printer engine.

10. A print control apparatus, comprising:
generator means for generating bit map data on the basis of print data;
storage means for storing the bit map data generated by said generator means; and
rotator means for rotating said image data in transferring the image data stored in said storage means to a printer engine.

11. The print control apparatus according to claim 10, wherein said rotator means causes a rotation in the case where the direction of a sheet in the generation of bit map data by said generator means differs from that of an actually printed sheet.

12. A print control method, using:
generator means for generating bit map data on the basis of print data; and
storage means for storing the bit map data generated by said generator means,
wherein said bit map data are rotated in transferring the bit map data stored in said storage means to the printer engine.

13. The print control method according to claim 12, wherein said rotation is caused if the direction of a sheet in the generation of bit map data by said generator means differs from that of an actually printed sheet.

14. A printer, comprising:
generator means for generating bit map data on the basis of print data;
storage means for storing the bit map data generated by said generator means;
a printer engine for making a print on the basis of said bit map data; and
rotator means for rotating said bit map data in transferring the bit map data stored in said storage means to said printer engine.

15. The printer according to claim 14, wherein said rotation is caused if the direction of a sheet in the generation of bit map data by said generator means differs from that of an actually printed sheet.
